(19) United States
(12) Patent Application Publication
(10) Pub. No.: US 2026/0254566 A1
(43) Pub. Date: Aug. 27, 2026

(54) HARQ ASSISTANCE INFORMATION FEEDBACK FOR POSITIVELY ACKNOWLEDGED DATA

(71) Applicant: Nokia Technologies Oy, Espoo (FI)

(72) Inventors: Abolfazl Amiri, Aalborg (DK); Klaus Ingemann Pedersen, Aalborg (DK); Troels Emil Kolding, Aalborg (DK); Uyoata Etuk Uyoata, Aalborg (DK)

(21) Appl. No.: 19/489,722

(22) PCT Filed: May 29, 2024
(86) PCT No.: PCT/EP2024/064774

§ 371 Date: Dec. 3, 2025

(30) Foreign Application Priority Data
Jul. 10, 2023 (GB) 2310529.9

(51) Int. Cl. H04L 1/1812; H04L 1/00

(52) U.S. Cl. CPC H04L 1/1812; H04L 1/0003

(57) ABSTRACT

Described herein is a user equipment (UE) configured to support a Hybrid Automatic Repeat Request, HARQ, process when communicating with a network node of a radio access network, the UE comprising: at least one processor, and at least one memory storing instructions that, when executed by the at least one processor, cause the UE at least to: establish a connection towards the network node; receive, from the network node, at least one Transport Block, TB; carry out a Cyclic Redundancy Check, CRC, for decoding the received at least one TB; in case of detecting a success in the decoding by determining that the received at least one TB passes the CRC check, prepare an assistance information; transmit, towards the network node, information for indicating the success and the assistance information for enabling the network node to trigger actions related to one or more next TBs based on the assistance information, wherein the UE is further configured to, in case of detecting the success, determine at least one transmission parameter based on Signal-to-Interference plus Noise Ratio, SINR, measurements performed by the UE, wherein at least one determined transmission parameter is different from a corresponding transmission parameter used for the transmission of the successfully decoded at least one TB, and wherein the UE is further configured to include information related to at least one determined different transmission parameter in the assistance information.

### TECHNOLOGY

The present disclosure relates to hybrid automatic repeat request, HARQ, process, in particular to feedback provided by the UE to the network side in an HARQ process.

### BACKGROUND

Any discussion of the background art throughout the specification should in no way be considered as an admission that such art is widely known or forms part of common general knowledge in the field.

Current single-bit HARQ feedback information can only carry the information regarding the result of Transport Block, TB (or Code Block, CB, or Code Block Group, CBG) CRC check at the UE. It is true that when the bit is equal to 1, complete information is conveyed and the gNB can move on to the next TB (or CBG) and remove the transmitted TB from its MAC layer buffer at the HARQ process. However, this single bit positive feedback has some limitations, one of which is the limited information it conveys to the gNB-which in this case simply is “it worked”. Therefore, the gNB does not know if the TB just made it or it could have been received correctly without the current amount of redundant data. Moreover, in some cases, the gNB is unaware if the channel conditions have become worse, and the next TB transmission will most probably fail if the same TB configuration is reused. However, at the UE side, there are additional information about the passed CRC of the TB that is not communicated to the gNB. For instance, depending to the output of the LDPC decoder, the UE knows how close it was to decode the packet. Such information has been discussed in the literature as soft feedback, where instead of a single-bit feedback, the UE sends a value in the range of [0,1] to show the likelihood of the decoding as in two extremes, 0 means not likely and 1 means definitely. However, there has been significant disagreements on standardizing such a feedback as it would require multiple feedback bits (depending on the quantization function). Moreover, all cases are for the TB failure scenario and they do not consider the successful transmission case. The introduction of multi-bit feedback for code block group-based transmissions, e.g. for extended reality (XR) use cases where the payloads are large, calls for a rethinking on how to best use multi-bit feedback and with the availability of larger bandwidths which could mean that the network can afford multi-bit HARQ feedback.

On the other hand, for delay sensitive communication, such as XR or ultra reliable-low latency communications (URLLC), the packet delay budget (PDB) values are in the order of a few milliseconds. Thus, relying on the legacy retransmission method may not be desirable. For example, if a TB is received at the UE side but the MCS is very close the decodable bound, the only response from the UE is an ACK response. However, the UE probably will not be able to recover the next TB if the channel conditions become slightly worse. Afterward, and when the next TB fails, a recovery mechanism will be triggered with several retransmissions to send the TB successfully. This process is both time- and radio resource-consuming, and by the time the TB is correctly recovered, the PDB may have been violated. Moreover, another scenario can happen as well, where the first TB was sent with more than enough redundancy (very low MCS index) that resulted in a very large TB size. Continuing with such configurations (unnecessary large TBs) can risk violating the PDB.

In view thereof, the present disclosure generally proposes apparatuses (such as UE, DU, CU, or the like) as well as corresponding methods to address some or all of the above-illustrated remarks, particularly in an efficient and flexible manner.

Particularly, in a broad sense, it may be seen that the present disclosure generally seeks to design HARQ assistance information that enables the transmitter-end to better decide how to best proceed with potential HARQ retransmissions or upcoming transmissions, to optimize the users' experienced QoS, subject to its QoS constraints (e.g. PDB), in particular in the case where the UE would otherwise just feed back an ACK message.

### SUMMARY

In accordance with an aspect of the present disclosure, there is provided a User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
   establish a connection towards the network node;
   receive, from the network node, at least one Transport Block, TB;
   carry out a Cyclic Redundancy Check, CRC, for decoding the received at least one TB;
   in case of detecting a success in the decoding by determining that the received at least one TB passes the CRC check, prepare an assistance information;
   transmit, towards the network node, information for indicating the success and the assistance information for enabling the network node to trigger actions related to one or more next TBs based on the assistance information,
   wherein the UE is further configured to, in case of detecting the success, determine at least one transmission parameter based on Signal-to-Interference plus Noise Ratio, SINR, measurements performed by the UE, wherein at least one determined transmission parameter is different from a corresponding transmission parameter used for the transmission of the successfully decoded at least one TB, and
   wherein the UE is further configured to include information related to at least one determined different transmission parameter in the assistance information.

In some examples, the UE is further caused to:
prepare and transmit the assistance information to the network node when determining that at least one of following trigger conditions is fulfilled, the trigger conditions comprising:
   a predetermined number of consecutive receptions of transmissions for the at least one TB are detected by the UE;
   a predetermined number of consecutive and successful decoding of transmissions for the at least one TB are detected by the UE; and
   a measured channel quality value related to channel condition between the UE and the gNB is detected by the UE to be below a predetermined channel quality threshold after receiving the at least one TB from the gNB, based on a channel quality measurement performed by the UE at the time of receiving and decoding the at least one TB, in particular based on the SINR measurements.

In some examples, a transmission parameter is related to at least one of number of retransmissions required for successful decoding of a TB at the UE, Modulation and Coding Scheme (MCS), and rank.

In some examples, the UE is further caused to:
measure an SINR value for the received at least one TB;
calculate a difference between a preset decodable SINR value and the measured SINR value; and
based on the calculated SINR difference value, determine the at least one transmission parameter for transmission of the one or more next TBs,
wherein in particular, the UE is further caused to indicate to the gNB the calculated SINR difference value for indicating the gNB to determine the at least one transmission parameter for transmission of the one or more next TBs.

In some examples, the UE is further caused to:
determine the at least one transmission parameter for transmission of the one or more next TBs when detecting that a number of retransmissions used for the successfully decoded at least one TB is larger than a predetermined retransmission number threshold.

In some examples, the transmission parameter is related to MCS, and the UE is further caused to:
indicate the network node, via the assistance information, to transmit the one or more next TBs with a modified MCS different from an initial MCS used for the successful transmission of the at least one TB.

In some examples, the UE is further caused to:
indicate the network node to increase an index of the initial MCS and to transmit the one or more next TBs with the modified MCS with the increased index, when determining that the calculated SINR difference value is larger than a first predetermined SINR threshold value,
wherein the first predetermined SINR threshold value indicates a minimum SINR difference value for triggering a modification of the MCS.

In some examples, the UE is further caused to:
indicate to the network node a maximum MCS index to which the initial MSC can be modified for transmitting the one or more next TBs with the modified MCS, wherein the maximum MSC index is determined by the UE as an index with which the UE could have decoded the received at least one TB with a predetermined block error probability.

In some examples, the UE is further caused to:
indicate the network node to decrease an index of the initial MCS and to transmit the one or more next TBs with the modified MCS with the decreased index, when determining that decoding of the one or more next TBs will fail when being transmitted by the gNB with the initial MCS, preferably by determining that the calculated SINR
difference value is smaller than a second predetermined SINR threshold value, wherein in particular the decreased MSC index is determined by the UE as an index with which the UE could have decoded the received at least one TB with a predetermined block error probability.

In some examples, the transmission parameter is related to number of retransmissions required for successful decoding of a TB at the UE and the UE is configured with a maximum allowed number of retransmissions required for successful decoding of a TB at the UE, wherein the UE is further caused to:
indicate the network node, via the assistance information, to decrease the maximum allowed number of retransmissions when determining that the calculated SINR difference value is larger than a third predetermined SINR threshold value.

In some examples, the UE is further configured to:
based on a preconfigured function, determine the decreased maximum allowed number of retransmissions, wherein the preconfigured function comprises input parameters including the calculated SINR difference value.

In some examples, the transmission parameter is related to rank, and the UE is further caused to:
indicate the network node, via the assistance information, to transmit the one or more next TBs with a modified rank different from an initial rank used for the successful transmission of the at least one TB.

In some examples, the UE is further caused to:
indicate the network node to increase the initial rank to the modified rank for transmitting the one or more next TBs, when determining that the calculated SINR difference value is larger than a fourth predetermined SINR threshold value,
wherein the fourth predetermined SINR threshold value indicates a minimum SINR difference value for triggering a modification of the rank.

In some examples, the UE is further caused to:
indicate to the network node a maximum rank to which the initial rank can be modified for transmitting the one or more next TBs with the modified rank, wherein the maximum rank is determined by the UE as a rank with which the UE could have decoded the at least one received TB with a predetermined block error probability.

In some examples, the UE is further caused to:
indicate the network node to decrease the initial rank to the modified rank and to transmit the one or more next TBs with the modified rank, when determining that decoding of the one or more next TBs will fail when being transmitted by the gNB with the initial rank, preferably when determining that the calculated SINR difference value is smaller than a fifth predetermined SINR threshold value.

In some examples, the received at least one TB comprises a plurality of Code Block Groups, CBGs, wherein the UE is further caused to:
if determining that all of the plurality of CBGs are successfully decoded, determine that the received at least one TB passes the CRC check, wherein each CBG comprises a plurality of Code Blocks, and the UE in further caused to determine that a CBG is successfully decoded when determining that all CBs comprised in the CBG pass the CRC check; and
transmit the assistance information to the network node for the at least one TB.

In some examples, the UE is further caused to transmit the assistance information via an Uplink Channel Information, UCI.

In accordance with another aspect of the present disclosure, there is provided a User Equipment, UE, configured to support a Hybrid Automatic Repeat Request, HARQ, process when communicating with a network node of a radio access network, the UE comprising: at least one processor, and
at least one memory storing instructions that, when executed by the at least one processor, cause the UE at least to:
   establish a connection towards the network node;
   receive, from the network node, at least one Code Block, CB;
   carry out a Cyclic Redundancy Check, CRC, for decoding the received at least one CB;
   in case of detecting a success in the decoding by determining that the received at least one CB passes the CRC check, prepare an assistance information,
   transmit, towards the network node, information for indicating the success and the assistance information for enabling the network node to trigger actions related to one or more next CBs based on the assistance information,
   wherein the UE is further configured to, in case of detecting the success, determine at least one transmission parameter based on Signal-to-Interference plus Noise Ratio, SINR, measurements performed by the UE, wherein at least one determined transmission parameter is different from a corresponding transmission parameter used for the transmission of the successfully decoded at least one CB, and
   wherein the UE is further configured to include information related to at least one determined different transmission parameter in the assistance information.

In accordance with another aspect of the present disclosure, there is provided a User Equipment, UE, configured to support a Hybrid Automatic Repeat Request, HARQ, process when communicating with another user equipment, the UE comprising:
at least one processor, and
at least one memory storing instructions that, when executed by the at least one processor, cause the UE at least to:
   establish a radio connection towards the another user equipment via a direct link using device-to-device communication or sidelink communication;
   receive, from the another user equipment, at least one Transport Block, TB, and/or at least one Code Block, CB;
   carry out a Cyclic Redundancy Check, CRC, for decoding the received at least one TB and/or at least one CB;
   in case of detecting a success in the decoding by determining that the received at least one TB and/or at least one CB passes the CRC check, prepare an associated assistance information,
   transmit, towards the another user equipment, information for indicating the success and the assistance information for enabling the another user equipment to trigger actions related to one or more next TBs and/or CBs based on the associated assistance information,
   wherein the UE is further configured to, in case of detecting the success, determine at least one transmission parameter based on Signal-to-Interference plus Noise Ratio, SINR, measurements performed by the UE, wherein at least one determined transmission parameter is different from a corresponding transmission parameter used for the transmission of the successfully decoded at least one TB and/or at least one CB, and
   wherein the UE is further configured to include information related to at least one determined different transmission parameter in the assistance information.

In accordance with another aspect of the present disclosure, there is provided a User Equipment, UE, configured to support a Hybrid Automatic Repeat Request, HARQ, process when communicating with a network node of a radio access network, the UE comprising: at least one processor, and at least one memory storing instructions that, when executed by the at least one processor, cause the UE at least to:
establish a connection towards the network node;
receive, from the network node, a UE capability request, send, towards the network node, a UE capability information including the UE's capability to support sending assistance information in case of detecting a success in decoding at least one received data packet, wherein at least one data packet, in particular, includes a Transport Block, TB, and/or a Code Block, CB,
receiving, from the network node, a configuration message including, in case the UE supports sending the assistance information, a configuration related to the use of the assistance information,
in case of detecting a success in the decoding of the at least one received data packet, prepare an associated assistance information based on the configuration,
transmit, towards the network node, information for indicating the detected success and the prepared associated assistance information for enabling the network node to trigger actions related to one or more next data packets based on the assistance information, wherein the UE is further configured to include information related to at least one transmission parameter different from a corresponding transmission parameter used for the transmission of the successfully decoded at least one data packet in the assistance information.

In accordance with another aspect of the present disclosure, there is provided a User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
   establish a connection towards the network node;
   receive, from the network node, a UE capability request,
   send, towards the network node, a UE capability information including the UE's capability to support sending assistance information in case of detecting a success and/or failure in decoding at least one received data packet, wherein at least one data packet, in particular, includes a Transport Block, TB, and/or a Code Block, CB,
   receiving, from the network node, a configuration message including, in case the UE supports sending the assistance information, a configuration related to the use of the assistance information,
   in case of detecting a success and/or failure in the decoding of the at least one received data packet, prepare an associated assistance information based on the configuration, transmit, towards the network node, the prepared assistance information for enabling the network node to trigger actions related to at least one data packet to be send based on the assistance information,
   wherein the UE is further configured to include information related to at least one transmission parameter different from a corresponding transmission parameter used for the transmission of the successfully and/or unsuccessfully decoded at least one data packet in the assistance information.

In accordance with another aspect of the present disclosure, there is provided a network node of a radio access network, configured to support a hybrid automatic repeat request, HARQ, process when communicating with a User Equipment, UE, the network node comprising:
at least one processor, and
at least one memory storing instructions that, when executed by the at least one processor, cause the network node at least to:
   establish a connection towards the UE;
   transmit, to the UE, at least one Transport Block, TB;
   receive, from the UE, information for indicating a success in decoding the at least one TB at the UE and an associated assistance information prepared by the UE, wherein the assistance information includes information related to a transmission parameter different from a corresponding transmission parameter used for the transmission of the at least one successfully decoded TB; and
   trigger actions related to one or more next TBs based on the assistance information for supporting successful decoding of the one or more next TBs at the UE.

In some examples, the network node is further caused to:
transmit to the UE a resource radio control, RRC, message for configuring the assistance information and for indicating the UE to send to the network node the assistance information in case of a success in decoding the at least one TB at the UE.

In some examples, the network node is further caused to:
transmit to the UE a first control element for configuring a first assistance information, for indicating determination of a first transmission parameter and for indicating the UE to send to the network node the first assistance information, in particular in case of a success in decoding the at least one TB at the UE; and
after receiving the first assistance information, transmit to the UE a second control element for configuring a second assistance information, for indicating determination of a second transmission parameter and for indicating the UE to send to the network node the second assistance information, in particular in case of a success in decoding the at least one TB at the UE,
wherein the first transmission parameter is different from the second assistance information, wherein the gNB is configured to configure and determine to transmit the first control element and the second control element based on information at the gNB related to the at least one TB.

In some examples, the network node is configured to:
perform transmission related to the one or more next TBs with at least one transmission parameter indicated by the UE via the assistance information, wherein at least one determined transmission parameter is different from a corresponding transmission parameter used for the transmission of the at least one successfully decoded TB.

In some examples, a transmission parameter is related to at least one of number of retransmissions required for successful decoding of a TB at the UE, Modulation and Coding Scheme, MCS and rank.

In some examples, the assistance information indicates to transmit the one or more next TBs with a modified Modulation and Coding Scheme, MCS different from an initial MCS used for the successful transmission of the at least one TB wherein the network node is further caused to:
transmit the one or more next TBs with the modified MCS,
wherein in case of receiving from the UE an indication of a MCS index offset, which results in a maximum MCS index that is equal to the sum of the offset value to the initial transmission's MCS, transmit the one or more next TBs with the modified MCS being lower than or equal to the indicated maximum MCS index.

In some examples, the network node is further caused to configure the UE with a maximum allowed number of retransmissions required for successful decoding of a TB at the UE,
wherein the assistance information indicates to decrease said maximum allowed number of retransmissions for the one or more next TB, wherein the network node is further caused to decrease said maximum allowed number of retransmissions for the one or more next TBs.

In some examples, the assistance information indicates to transmit the one or more next TBs with a modified rank different from an initial rank used for the successful transmission of the at least one TB, wherein the network node is further caused to:
transmit the one or more next TBs with the modified rank,
wherein in case of receiving from the UE an indication of a maximum rank, transmit the one or more next TBs with the modified rank being lower than or equal to the indicated maximum rank.

In accordance with yet another aspect of the present disclosure, there is provided a system, configured for performing a hybrid automatic repeat request, HARQ, process, the system comprising:
a User Equipment, UE, in accordance with any one of the examples related to the above aspect related to the UE; and
a network node in accordance e.g., with any one of the examples related to the above aspect related to the network node.

In accordance with yet another aspect of the present disclosure, there is provided a method of a User Equipment, UE, configured to support a Hybrid Automatic Repeat Request, HARQ, process when communicating with a network node of a radio access network, the method comprising:
establishing a connection towards the network node;
receiving, from the network node, at least one Transport Block, TB;
carrying out a Cyclic Redundancy Check, CRC, for decoding the received at least one TB;
in case of detecting a success in the decoding by determining that the received at least one TB passes the CRC check, preparing an assistance information;
transmitting, towards the network node, information for indicating the success and the assistance information for enabling the network node to trigger actions related to one or more next TBs based on the assistance information,
wherein the UE is further configured to, in case of detecting the success, determining at least one transmission parameter based on Signal-to-Interference plus Noise Ratio, SINR, measurements performed by the UE, wherein at least one determined transmission parameter is different from a corresponding transmission parameter used for the transmission of the successfully decoded at least one TB, and
wherein the UE is further configured to include information related to at least one determined different transmission parameter in the assistance information.

In accordance with yet another aspect of the present disclosure, there is provided a method of a network node of a radio access network, configured to support a hybrid automatic repeat request, HARQ, process when communicating with a User Equipment, UE, the method comprising:
establishing a connection towards the UE;
transmitting, to the UE, at least one Transport Block, TB;
receiving, from the UE, information for indicating a success in decoding the at least one TB at the UE and an associated assistance information prepared by the UE, wherein the assistance information includes information related to a transmission parameter different from a corresponding transmission parameter used for the transmission of the at least one successfully decoded TB; and
triggering actions related to one or more next TBs based on the assistance information for supporting successful decoding of the one or more next TBs at the UE.

In accordance with yet another aspect of the present disclosure, there is provided a computer program comprising instructions for causing an apparatus to perform the method according to any one of the above aspects.

In accordance with yet another aspect of the present disclosure, there is provided a memory storing computer readable instructions for causing an apparatus to perform the method according to any one of the above aspects.

Furthermore, according to some example embodiments, there is provided a UE comprising respective suitable means configured for performing the respective steps as disclosed in the present disclosure.

Furthermore, according to some example embodiments, there is provided a network node comprising respective suitable means configured for performing the respective steps as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

The invention/use of assistance information is applicable in different circumstances, e.g. in accordance with one of the examples mentioned, with two or more of the examples combined, or in case of other examples, thus e.g. independent of the listed ones.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a high level block diagram of data flow chart for an example of multiplexing several IP packets from different RBs into one MAC PDU which later is scheduled into one TB; and

FIG. 2 schematically illustrates an example of a signaling/messaging diagram according to an example embodiment of the present disclosure.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1

### INCORPORATED BY REFERENCE

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0 (2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

This application is related to more detailed hybrid automatic repeat request (HARQ) response in order to facilitate more efficient radio resource usage for coming transmissions. We focus assistance for cases where simple positive HARQ feedback would otherwise be signaled. In fact, with current standards for the HARQ response (e.g. 3GPP TS 38.321 V17.3.0 (2022-12) section 5.3.2), the UE is allowed to send a single bit (1: ACK or 0: NACK), to inform the gNB of the result of the reception of a certain transport block (TB). At the UE side, depending on the output of the Cyclic Redundancy Check (CRC) check, the feedback is generated and reported to the gNB. One general shortcoming of using the single-bit feedback is that it omits additional information regarding the quality of TB transmission. In other words, if the gNB receives an ACK bit as the HARQ feedback, there is only limited guidance to let the gNB know how to proceed. More information could give guidance to different questions, for instance:
1. If the same modulation and coding scheme (MCS) should be used for the next TB transmission?
2. Should the gNB use a different configuration for the next transmissions to avoid possible failures?

Thus, there is a need to propose a new method where the positive HARQ feedback information is complemented with assistance information (which is only sent when certain conditions are met) to guide the gNB towards a better future data transmission strategy. The certain conditions are configured to avoid extra overload in the signalling.

Before going into detail of the example embodiments of the present disclosure, it may also be worthwhile to provide a brief description—from a high/abstract level perspective—that could serve as a basis for understanding possible underlying technologies (and the terminologies used therein) that are described in the present disclosure. However, as has been indicated above, the techniques described in the present disclosure may be applicable to some other possible technologies, for example with suitable/appropriate adaptation wherever necessary, as can be understood and appreciated by the skilled person.

References are now made to the figures. In particular, it is to be noted that identical or like reference numbers used in the figures of the present disclosure may, unless indicated otherwise, indicate identical or like elements, such that repeated description thereof may be omitted for reasons of conciseness.

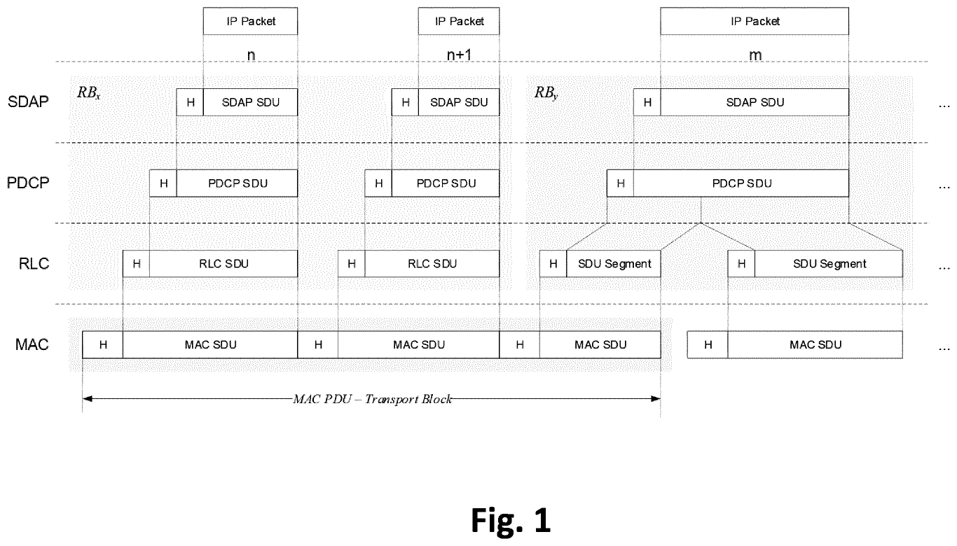

FIG. 1 schematically illustrates an example of a high-level block diagram of data flow chart for an example of multiplexing several IP packets from different RBs into one MAC PDU which later is scheduled into one TB. This figure is in accordance with 3GPP TS 38.300 V17.3.0 (2022-12) section 6.6.

The current 5G NR specifications include options for multiplexing different IP packets, and data from different RBs into one MAC PDU as pictured in Error! Reference source not found. (see e.g. the overview in 3GPP TS 38.300 V17.3.0 (2022-12), section 6.6). Prior to the actual transmission of MAC PDU in one transport block on the downlink physical-layer, the following processing steps happen:
1. Transport block CRC attachment;
2. Code block segmentation and code block CRC attachment;
3. Channel coding: LDPC coding;
4. Physical-layer hybrid-ARQ processing;
5. Rate matching;
6. Scrambling;
7. Modulation: QPSK, 16QAM, 64QAM, 256QAM, and 1024QAM;
8. Layer mapping;
9. Mapping to assigned resources and antenna ports.
   Options with CBG-based HARQ transmission are also supported by 5G NR. CBG-based transmissions are e.g. specified in Section 5.1.7 of 3GPP TS 38.214 V17.3.0 (2022-12), entitled “Code block group based PDSCH transmission”. Details of HARQ feedback for CBG based transmissions are e.g. specified in 3GPP TS 38.213 V17.3.0 (2022-12), section 9.1.1 entitled “CBG-based HARQ-ACK codebook determination”. Aspects of CBG-based transmissions also appear in e.g. the MAC specification (3GPP TS 38.321 V17.3.0 (2022-12)). The basic principle is that the TB is organized into multiple CBs. The maximum size of a CB is 8448 bits. The CBs are grouped into CBGs. For each received TB, the receiver provides feedback to indicate which CBGs are in error, and only the erroneously received CBGs are thereafter retransmitted by the transmitter. For transmission of large TB sizes (for example, as is the case for XR use cases as defined in 3GPP TR 38.838 V17.0.0 (2021-12)) such techniques are promising. Cases with up to 8 CBGs per TB are supported by current NR specs. More generally, the maximum number of CBGs per TB is configurable as C E {2, 4, 6, 8} for the PDSCH.

The Physical Downlink Control Channel (PDCCH) is used to schedule DL transmissions on PDSCH and UL transmissions on PUSCH, where the Downlink Control Information (DCI) on PDCCH e.g. includes:
Downlink assignments containing at least modulation and coding format, resource allocation, and hybrid-ARQ information related to DL-SCH;
Uplink scheduling grants containing at least modulation and coding format, resource allocation, and hybrid-ARQ information related to UL-SCH.

Notice that there is one DL scheduling grant per UE, per carrier and codeword only, and that it includes one modulation and coding format (also known as MCS). The DCI format for DL scheduling on the PDSCH that supports CBG transmission is Format 1_1 (see details in 3GPP TS 38.212 and 38.214). There, CBG Transmission Information (CBGTI) field determines the number of CBGs per TB and then the CBs will be assigned into C (e.g. C∈{2, 4, 6, 8}) groups.

In this application it is proposed to use the information that is available at the UE side after trying to decode a TB, to provide assistance information to guide the gNB on how to proceed with the upcoming transmissions.

One main innovative step is to configure sending the assistance information, prepare assistance information and signal it to the network. In case of a successful transmission and reception, and if certain triggering conditions are valid at the UE (different, separate options which may be combined with each other in total or in part):
1. Inform the gNB to adjust the MCS with a delta_MCS value. This can be the case when the initial transmission was sent with too conservative MCS and the MCS can be adjusted to a higher index value. On the other hand, it can be lowered for the case where the upcoming transmission may fail with the current MCS (e.g., When the current transmission was very close to fail or when large number of retransmissions have been used to achieve successful transmission). Similar information can be carried by sending a SINR margin value instead of the delta_MCS. Both values (delta_MCS or SINR margin) are calculated in a way to guarantee a given block error probability. Therefore, it is in particular proposed to indicate by the UE to the gNB to use a modified MCS index different from that used in the initial transmission of the TB which the UE has successfully decoded.
   For instance, if the first (initial) TB transmission was sent with a very conservative (low) MCS, the UE can indicate that it could have decoded the TB if the SINR was +3 dBs higher. Therefore, the gNB, can use this info to increase the MCS accordingly.
   Similarly, if the UE, by measuring the channel, observes a 2 dB reduction in the SINR, can indicate −2 dB, and the gNB will know that it should lower the MCS of the next TB or otherwise it will most probably fail.
2. Suggest to adjust the maximum number of reTX (if available at the UE). Preferably, the gNB has configured the UE with a maximum number of retransmissions allowed at the UE for successful decoding of a TB at the UE. For instance, the UE has successfully decoded at least one TB with this maximum number of retransmissions. It is then indicated by the UE to the gNB to modify this configured maximum number of retransmissions, e.g., depending on the information at the UE after successful decoding of the at least one TB. Therein, a number of retransmissions is an integer larger than 1, and could e.g. be 2, 3, 4, . . . , n. For instance, if the UE indicates 4 as an maximum to gNB, then gNB may select 3 consecutive retransmissions, and e.g. only after the third received retransmission the UE sends an ACK or NACK to gNB.
3. Indicate to gNB the maximum rank for which it could have decoded the TB with a given block error probability target. It is in particular proposed to indicate by the UE to the gNB to use a modified rank different from that used in the initial transmission of the TB which the UE has successfully decoded.

Regarding the triggering conditions: these are configured for two main reasons:
1. to avoid the extra overhead of signalling. For instance, sending assistance information per each ACK response brings a lot of overhead and it should be controlled.
2. to avoid sending the information that is not statistically sufficient. For example, the UE should not ask to increase the MCS based on only one ACK response.

The assistance information can be signalled via UCI in UL to guide gNB on how to proceed with the rest of the transmissions.

In this application, that the UE prepares an assistance information e.g., in case of successfully decoding at least one received TB refers to that the UE prepares at least one assistance information, wherein one assistance information comprises in particular one or more pieces or units of assistance information, i.e., one assistance information comprises one or more assistance information units. In particular, one assistance information unit is configured to indicate one determined transmission parameter to be used for the next transmissions for one or more next TBs (preferably different from the corresponding transmission parameter used for the successfully decoded at least one TB, but also may be the same). Accordingly, one assistance information may comprise one or more assistance information units indicating the same respective transmission parameter and further to that one or more assistance information units indicating different transmission parameters compared with those used for the successfully decoded at least one TB. The one or more assistance information units comprised in one assistance information are preferably coded into one message transmitted from the UE to the gNB, in particular in case of successfully decoding at least one received TB at the UE. For instance, the UE is configured to transmit to the gNB an ACK and separate one or more assistance information units, or an ACK and an assistance information, wherein the ACK and the respective assistance information (units) are coded in one common message to be transmitted to the gNB.

In this application, retransmission refers to that the transmitter sends an exact copy of the first (initial) transmission which has failed or succeeded; however, a new transmission can be different from the initial transmission (possibly different characteristics such as different modulation and coding, etc.). There is another difference in terms of the ability of the receiver to combine the initial failed TB with the (re/new)-transmissions. Legacy receivers can only combine information if a retransmission (same MCS) is sent as it is an exact copy and signals can be summed. This is not the case for a new transmission, for which the receivers can combine new transmissions, i.e., new TBs (with different MCS) with the initial TB.

Whether a retransmission or a new transmission is to be performed by the transmitter (i.e., the network node) can be indicated by a New Data Indicator (NDI). For instance, NDI set to 1 indicates new transmission and set to 0 indicates retransmission. If the NDI is set to 1, the UE can flush the first failed TB from its memory and start over with a fresh TB configuration.

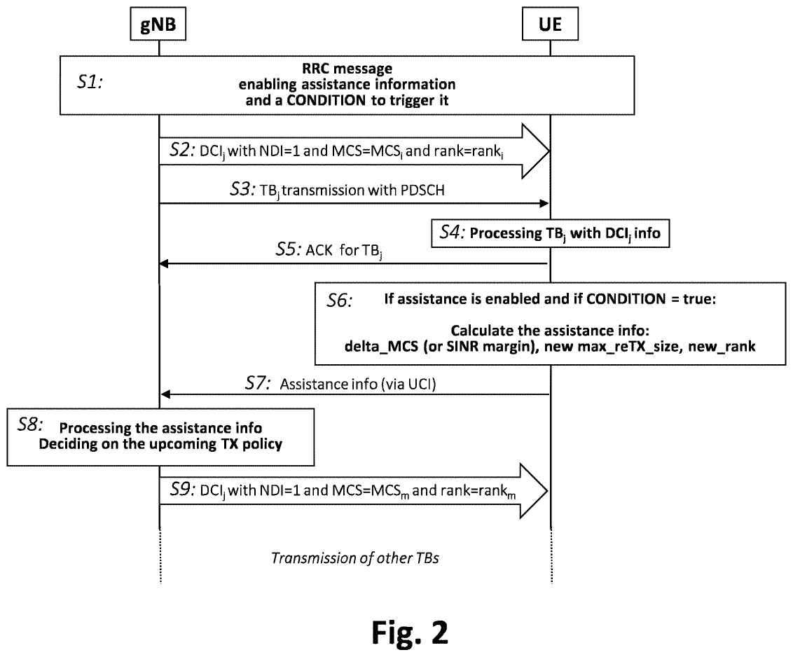

FIG. 2 show a signalling diagram of the proposed assistance information scheme.
Step S1: gNB sends an RRC message to configure the assistance information:
   1. Assistance information is enabled for each or a set of consecutive successful receptions. Furthermore, a new rule can be defined (noted as CONDITION in FIG. 2) to determine when to trigger the assistance information, e.g. number of consecutive successful transmissions or when the channel conditions become worse (the UE expects a NACK for the next TB) that can be quantified based on measured SINR or any other channel quality measurement metric.
   2. Format of which assistance information to be provided is configured as the UE can send: Number of required retransmissions (reTX), new MCS for the new transmissions, new MIMO rank for the next data transmissions.
   Then, during the established connection, UE knows that in case of ACK it has to send the assistance information specified via the RRC message earlier.

The gNB may additionally or alternatively configure the UE to send a specific assistance information (unit) for indicating the UE to transmit to the gNB a (indication for a determined) specific transmission parameter. For instance, the gNB configures the UE to send assistance information about rank and then later decides to ask the UE to include information about MCS index, e.g., based on information available at the gNB related to the at least one transmitted TB, channel condition and etc.
Step S2: The gNB sends a scheduling DCI for TBⱼ where new data indicator (NDI) is 1 and MCS index is MCSi, together with other scheduling information.
Step S3: The gNB transmits the scheduled TBⱼ on PDSCH channel.
Step S4: The UE receives the TB and tries to decode it based on DCI's content.
Step S5: In case of a successful reception, the UE sends an ACK message (as legacy).
Step S6: In case of validity of the CONDITION for triggering the assistance information: The UE calculates them (based on RRC configurations or any other session setup information from the network) (in at least one of the following manners):
   Option 1. This information could be in the form of asking the gNB to modify the current MCS index. This can indicate increasing the index as it is very conservative. In another embodiment, the UE can report the maximum MCS index for which it could have decoded the TB with a given block error probability target. Similarly, the UE can ask to decrease the MCS index as it expects the next TB will be failed with the current MCS.
   Option 2. It can also include information on suggesting to reduce the maximum number of reTX (if available at the UE), or any other assistance information that helps the gNB for the upcoming transmissions.
   Option 3. The UE can indicate the maximum rank for which it could have decoded the TB with a given block error probability target. This value can be higher that the initial TB rank if the initial transmission was too conservative, or it can be lower for the case of expecting a NACK in the upcoming TB transmission(s).

More information regarding UE procedures is discussed in UE procedures for Step S6.

In particular, the configuration provided in accordance with this application may determine that the UE is to prepare assistance information only when certain criteria (for instance the above described trigger conditions) are fullfilled, and thus not always assistance information is prepared and thus not always sent together with each ACK.

Further, the UE may be configured to prepare assistance information preferably independent of success or failure of decoding the at least one received TB, but based on other criteria like conditions changing, or other transmission parameters better suited for UE, and thus assistance information may be prepared and sent independently from sending ACK or NACK. Further, the UE can initiate the request to modify the assistance information. For example, if the UE is only configured to send info for the NACK case, it can ask to include assistance information for the ACK case as well. Such dynamic modifications can be carried via control elements (no need for RRC).
Step S7: The UE sends the calculated information in UL (for instance using UCI).
Step S8: The gNB processes the assistance information and may use them for future TB transmissions. More information regarding gNB procedures is discussed in gNB procedures for Step S8.
Step S9: The gNB sends a scheduling DCI (if there are more TBs to be transmitted), and continues with the DL data transmission (it may or may not consider the UE's recommendation).
   UE procedures for Step S6

For each of the 3 options mentioned in step S6, the UE may follow the following procedure:
a) The UE measures the experienced SINR for the transmission of TBⱼ (Sⱼ).
b) The UE compares Sⱼ with its own predefined decodable SINR value (S_{D}), and calculates the SINR difference as S_{newtx}=S_{D}−Sⱼ
   Remark: The UE can also use other sources to determine the quality of the received succeeded TB such as the output of the TB decoder function. For instance, for 5G NR, the output of the low-density parity check (LDPC) decoder that gives a measure on how close is the receiver to fully decode the TB can be used.

Now, for each of the 3 options mentioned in step S6, the UE may continue as the following:
Option 1) The UE can be configured with a (first) threshold value T that shows the minimum amount of excessive received SINR that can trigger MCS change. In other words, if S_{newtx}>T, then the UE can ask the gNB to increase the MCS index for the upcoming transmissions to improve the spectral efficiency. Similarly, with another (a second) threshold value of R, and if S_{newtx}<R, the UE can ask the gNB to reduce the MCS index.
Option 2) Similar to Option 1, a (third) threshold Q can be used to trigger a recommendation from the UE to reduce the maximum number of retransmission at the gNB. Thus, if S_{newtx}>Q, then the UE can ask the gNB to reduce the number by 1 or any other value. In another embodiment, the UE may use a predefined function to calculate the a new max number of required retransmissions. This can be simply achieved via

$${N}_{retx} = ceil ( {10}^{\frac{Snewtx}{10}} ) - 1 ,$$

where ceil stands for the ceiling function. This function simply comes from the retransmission gain for each time that increases the aggregated SINR at the receiver. Use of any other function is not prohibited.
   In option 1, the first threshold T is mostly seen as a “sensitivity threshold” where if the measured SINR and previously reported SINR have a difference less than the first threshold T, the UE will not react (or it can be interpreted as the gNB has an accurate information and the UE does not need to bother). However, the third threshold Q in option 2 is provisioned to be higher than the first threshold T in option 1, as the channel should be much better (or worse) so the UE decides to indicate the change of maximum Retransmission number.
Option 3) Similar to Option 1, the UE can use a predefined (fourth) threshold L, and compare it to S_{newtx} and decide if the upcoming transmission should be sent with a higher MIMO transmission rank, so the next TB is sent successfully and efficiently. Alternatively or additionally, the UE can use a predefined (fifth) threshold W, and compare it to S_{newtx} and decide if the upcoming transmission should be sent with a lower MIMO transmission rank, so the next TB is sent successfully and efficiently.
   The fourth threshold L and the fifth threshold W are preferably different from the first threshold T and the second threshold R in option 1, wherein the thresholds in option 3 can in principle be dependent on the multi-antenna combining gains, where the UE can decide what rank is more suitable.

### gNB Procedures for Step S8

In the following, it is listed the possible procedure at the gNB based on the received assistance information provided by the UE.
1. No action mode: The gNB ignores the UE recommendations and continues to follow the legacy procedures.
2. Action mode: In this case the gNB considers the UE recommendation to adjust the configuration for the upcoming TB transmissions. For instance, it can chose the recommended MCS (that is based on the offset adjusted MCS that comes as a result of the CQI and delta MCS assistance information) as a baseline to determine the best MCS for the next TB. Additionally, it can adjust the value of Nᵣₑₜₓ or transmission rank based on UE's recommendation.

### ADDITIONAL EMBODIMENTS

The above solution is easily applicable for the CBG based transmission and HARQ feedback, as the case of scenario 1: TB passes the CRC check, translates into all CBGs pass the CRC check. For the CBG based transmission, the UE's assistance information is for all the CBGs. In particular, the UE detects a successfully decoded CBG: if all the CBs belonging to that CBG pass the CRC check; and the UE detects a failed to be successfully decoded CBG: if at least one CB belonging to that CBG fails the CRC check.

In summary, the solution proposed in this application comprises the following main innovative steps:
Configuring the UE to send assistance information and a condition to trigger sending it to guide the gNB in the retransmission process.
Configuring the UE to send assistance information to guide gNB for the future transmissions even if the TB transmission was successful.
Proposing several options for the assistance information that can be used at the gNB.

The following technical advantages are provided in accordance with the solution proposed in this application:
in particular, for the ACK case:
Option 1 and 3: Adjusting the values for right MCS and transmission rank as soon as possible can help increasing the spectral efficiency, reducing unnecessary retransmissions and save in latency and downlink capacity.
Option 2: Reconfiguring the max reTX value can help the gNB to optimize its operations and reduce operation complexities and save memory allocation for each HARQ process.

It is noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU, etc.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

Inventive technical features in the above-illustrated example embodiments may also be combined with or applicable to at least one of the following further embodiments, which e.g. relate to Code Block, CB, device-to-device communication or sidelink communication, UE capability and assistance configuration, and/or multicast. In general, in systems in which HARQ processes are used. Parts of the embodiments might be combined.

In a further embodiment related to Code Block, CB, a UE may be described as follows:
A User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
establish a connection towards the network node;
receive, from the network node, at least one Code Block, CB;
carry out a Cyclic Redundancy Check, CRC, for decoding the received at least one CB;
in case of detecting a success in the decoding by determining that the received at least one CB passes the CRC check, prepare an assistance information,
transmit, towards the network node, information for indicating the success and the assistance information for enabling the network node to trigger actions related to one or more next CBs based on the assistance information,
wherein the UE is further configured to, in case of detecting the success, determine at least one transmission parameter based on Signal-to-Interference plus Noise Ratio, SINR, measurements performed by the UE, wherein at least one determined transmission parameter is different from a corresponding transmission parameter used for the transmission of the successfully decoded at least one CB, and
wherein the UE is further configured to include information related to at least one determined different transmission parameter in the assistance information.

In general, e.g. 3GPP TS 38.300 V17.3.0 (2022.12) section 6.2.4 describes HARQ-TB relationship: The HARQ functionality ensures delivery between peer entities at Layer 1. A single HARQ process supports one TB when the physical layer is not configured for downlink/uplink spatial multiplexing, and when the physical layer is configured for downlink/uplink spatial multiplexing, a single HARQ process supports one or multiple TBs.

Further, section 5.2.2 exemplarily describes the CRC attachment or both TB and CB: Physical-layer processing for physical downlink shared channel.

The downlink physical-layer processing of transport channels consists of the following steps:
Transport block CRC attachment;
Code block segmentation and code block CRC attachment;
Channel coding: LDPC coding.

The principles of assistance information determination are applicable to both TB and CB, e.g. as both have their own CRC and if a CRC check determines a failure an associated assistance information can be generated. The gNB is e.g. configured to determine or configure the UE regarding use of the assistance information, e.g. UE to generate assistance information on TB level, e.g. one assistance information generation if at least one failed CB has been identified and transmit the assistance info together with the NACK of the TB. Or, e.g. generate and send assistance information for the first failed CB and together with the NACK of the CB (or CBG), but not for additional failed CBs of a TB to reduce overhead and redundancy.

Such a UE may then be implemented in the environment of FIGS. 1 and 2.

In a further development related to device-to-device communication or sidelink communication, a UE may be described as follows:

A User Equipment, UE, configured to support a Hybrid Automatic Repeat Request, HARQ, process when communicating with another user equipment, the UE comprising:
at least one processor, and
at least one memory storing instructions that, when executed by the at least one processor, cause the UE at least to:
establish a radio connection towards the another user equipment via a direct link using device-to-device communication or sidelink communication;
receive, from the another user equipment, at least one Transport Block, TB, and/or at least one Code Block, CB;
carry out a Cyclic Redundancy Check, CRC, for decoding the received at least one TB and/or at least one CB;
in case of detecting a success in the decoding by determining that the received at least one TB and/or at least one CB passes the CRC check, prepare an associated assistance information,
transmit, towards the another user equipment, information for indicating the success and the assistance information for enabling the another user equipment to trigger actions related to one or more next TBs and/or CBs based on the associated assistance information,
wherein the UE is further configured to, in case of detecting the success, determine at least one transmission parameter based on Signal-to-Interference plus Noise Ratio, SINR, measurements performed by the UE, wherein at least one determined transmission parameter is different from a corresponding transmission parameter used for the transmission of the successfully decoded at least one TB and/or at least one CB, and
wherein the UE is further configured to include information related to at least one determined different transmission parameter in the assistance information.

According to 3GPP TS 38.300 V17.3.0 (2022-12) section 5.7 exemplary Sidelink processes are detailed:

Sidelink supports UE-to-UE direct communication using the sidelink resource allocation modes, physical-layer signals/channels, and physical layer procedures below.

Two sidelink resource allocation modes are supported: mode 1 and mode 2. In mode 1, the sidelink resource allocation is provided by the network. In mode 2, UE decides the SL transmission resources in the resource pool(s).

Physical Sidelink Control Channel (PSCCH) indicates resource and other transmission parameters used by a UE for PSSCH. PSCCH transmission is associated with a DM-RS.

Physical Sidelink Shared Channel (PSSCH) transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

Physical Sidelink Feedback Channel (PSFCH) carries HARQ feedback over the sidelink from a UE which is an intended recipient of a PSSCH transmission to the UE which performed the transmission. PSFCH sequence is transmitted in one PRB repeated over two OFDM symbols near the end of the sidelink resource in a slot.

The Sidelink synchronization signal consists of sidelink primary and sidelink secondary synchronization signals (S-PSS, S-SSS), each occupying 2 symbols and 127 subcarriers. Physical Sidelink Broadcast Channel (PSBCH) occupies 9 and 5 symbols for normal and extended CP cases respectively, including the associated DM-RS.

Sidelink HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In sidelink resource allocation mode 1, a UE which received PSFCH can report sidelink HARQ feedback to gNB via PUCCH or PUSCH.

In addition to the sidelink HARQ feedback the assistance information may be included. Dependent on the configuration a dedicated resource is allocated to transmit NACK and assistance information.

Such a UE may then be implemented in the environment of FIGS. 1 and 2.

In a further development related to UE capability and assistance configuration a UE may be described as follows:
A User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
establish a connection towards the network node;
receive, from the network node, a UE capability request,
send, towards the network node, a UE capability information including the UE's capability to support sending assistance information in case of detecting a success in decoding at least one received data packet, wherein at least one data packet, in particular, includes a Transport Block, TB, and/or a Code Block, CB,
receiving, from the network node, a configuration message including, in case the UE supports sending the assistance information, a configuration related to the use of the assistance information,
in case of detecting a success in the decoding of the at least one received data packet, prepare an associated assistance information based on the configuration,
transmit, towards the network node, information for indicating the detected success and the prepared associated assistance information for enabling the network node to trigger actions related to one or more next data packets based on the assistance information,
wherein the UE is further configured to include information related to at least one transmission parameter different from a corresponding transmission parameter used for the transmission of the successfully decoded at least one data packet in the assistance information.

Such a UE may then be implemented in the environment of FIGS. 1 and 2.

In a further development related to multicast and/or transmission on PUCCH or PUSCH a UE may be described as follows:

In general, e.g. 3GPP TS 38.300 V17.3.0 (2022-12) section 7.2 describes protocol sates including RRC_CONNECTED:
5GC-NG-RAN connection (both C/U-planes) is established for UE;
The UE AS context is stored in NG-RAN and the UE;
NG-RAN knows the cell which the UE belongs to;
Transfer of unicast data to/from the UE;
Transfer of MBS multicast/broadcast data to the UE over MRB(s);
Network controlled mobility including measurements.

Thus, RRC connected state is used in particular to transmit data, e.g. by using data packets, wherein a data packet may include at least one of data, unicast data, multicast data, broadcast data, TB, CB, CBG, etc.

For multicast service, gNB may deliver Multicast MBS data packets using the following methods:
PTP Transmission: gNB individually delivers separate copies of MBS data packets to each UEs independently, i.e., gNB uses UE-specific PDCCH with CRC scrambled by UE-specific RNTI (e.g., C-RNTI) to schedule UE-specific PDSCH which is scrambled with the same UE-specific RNTI.
PTM Transmission: gNB delivers a single copy of MBS data packets to a set of UEs, e.g., gNB uses group-common PDCCH with CRC scrambled by group-common RNTI to schedule group-common PDSCH which is scrambled with the same group-common RNTI (see e.g. section 16.10.5.4).

Further, a CFR configured by RRCReconfiguration message is defined for multicast scheduling as an ‘MBS frequency region’ with a number of contiguous PRBs confined within and with the same numerology as the DL BWP, and multicast scheduling may have specific characteristics (e.g., PDCCH, PDSCH and SPS configurations).

Two HARQ-ACK reporting modes are defined for MBS:
For the first HARQ-ACK reporting mode, the UE generates HARQ-ACK information with ACK value when a UE correctly decodes a transport block or detects a DCI format indicating an SPS PDSCH release; otherwise, the UE generates HARQ-ACK information with NACK value.
For the second HARQ-ACK reporting mode, the UE does not transmit a PUCCH that would include only HARQ-ACK information with ACK values.

HARQ-ACK feedback for multicast can be enabled or disabled by higher layer configuration per G-RNTI or per G-CS-RNTI and/or indication in the DCI scheduling multicast transmission, see e.g. section 16.10.5.7.

Thus, gNB is configured to enable HARQ-ACK feedback for multicast, together with the enablement the assistance information may be configured as well. E.g. a new HARQ-ACK reporting mode is added, in which the UE generates HARQ-NACK information with assistance information when a UE incorrectly decodes a transport block (failed TB), or failed CB, or failed CBG.

Further, in general HARQ ACK feedback may be configured to be transmitted using PUCCH or PUSCH. E.g. the IE BWP-UplinkDedicated is used to configure the dedicated (UE specific) parameters of an uplink BWP. (see e.g. 3GPP TS 38.331 V17.3.0 (2022-12) section 6.3.2 Radio resource control information element-BWP-Uplink dedicated). In pucch-ConfigurationListMulticast2 PUCCH configurations for two simultaneously constructed NACK-only feedback for MBS multicast (see TS 38.213, clause 9) can be configured, thus NACK-only feedback on PUCCH. The NACK feedback may be extended to include also the assistance information to be transmitted from the UE on the PUCCH, e.g. to support the network node to better select an appropriate transmission for e.g. re-transmission of a failed data packet, TB, CB, etc. Such configuration may e.g. be added to MAC-CellGroupConfig The IE MAC-CellGroupConfig is used to configure MAC parameters for a cell group, including DRX. includes e.g. harq-FeedbackEnablerMulticast-r17 ENUMERATED {dci-enabler, enabled} OPTIONAL, —Need and harq-FeedbackOptionMulticast-r17 ENUMERATED {ack-nack, nack-only} OPTIONAL, —Cond HARQFeedback, and may further include assistance configuration.

E.g. according to 3GPP TS 38.300 V17.3.0 (2022-12) section 10.3 Uplink Scheduling is exemplarily described,

In the uplink, the gNB can dynamically allocate resources to UEs via the C-RNTI on PDCCH(s). A UE always monitors the PDCCH(s) in order to find possible grants for uplink transmission when its downlink reception is enabled (activity governed by DRX when configured). When CA is configured, the same C-RNTI applies to all serving cells.

The gNB may cancel a PUSCH transmission, or a repetition of a PUSCH transmission, or an SRS transmission of a UE for another UE with a latency-critical transmission.

In addition, with Configured Grants, the gNB can allocate uplink resources for the initial HARQ transmissions and HARQ retransmissions to UEs.

Such allocated resources may then be used to transmit the assistance information as well.

E.g. according to 3GPP TS 38.300 V17.3.0 (2022-12) section 5.2.5.4

Asynchronous Incremental Redundancy Hybrid ARQ is supported. The gNB provides the UE with the HARQ-ACK feedback timing either dynamically in the DCI or semi-statically in an RRC configuration. Retransmission of HARQ-ACK feedback is supported by using enhanced dynamic codebook and/or one-shot triggering of HARQ-ACK transmission for (i) all configured CCs and HARQ processes in the PUCCH group, (ii) a configured subset of CCs and/or HARQ processes in the PUCCH group, or (iii) a dynamically indicated HARQ-ACK feedback instance. For HARQ-ACK of SPS PDSCH without associated PDCCH, in case of HARQ-ACK dropping due to TDD specific collisions, the HARQ-ACK feedback can be deferred to a next available PUCCH transmission occasion.

The UE may be configured to receive code block group based transmissions where retransmissions may be scheduled to carry a sub-set of all the code blocks of a TB.

The UE may in addition to the HARQ-ACK feedback also be configured related to the assistance information, The configuration can e.g. include at least one of the following timing, content, periodicity, applicability to a subset of failed CBs NACKs (e.g. transmit assistance information only for the first failed CB of a TB, e.g. as assistance information means additional overhead, which should be kept small, and as the content of the assistance information for multiple failed CBs of a TB might be identical due to same SNR signals measurements available).

Such a UE may then be implemented in the environment of FIGS. 1 and 2.

In a further embodiment the assistance information capability might be added to the UE capabilities. E.g. according to 3GPP TS 38.300 V17.3.0 (2022-12) section 7.5 The UE reports its UE radio access capabilities which are static at least when the network requests. The gNB can request what capabilities for the UE to report based on band information. The UE capability can be represented by a capability ID, which may be exchanged in NAS signalling over the air and in network signalling instead of the UE capability structure.

More details on how the UE compiles and transfers its UE capability information upon receiving a UECapabilityEnquiry from the network are e.g. described in section 5.6. The network initiates the procedure to a UE in RRC_CONNECTED when it needs (additional) UE radio access capability information.

The may request from the UE assistance information support indication if the UE is in delay sensitive communication, such as XR or ultra reliable-low latency communications (URLLC). In this case UE shall set the contents of UECapability Information message to include its capability to support assistance information in case of HARQ. This way the gNB is enabled to configure the assistance information generation and provision, e.g. dependent on the radio conditions, e.g. in bad conditions it might be beneficial to receive customized assistance information to increase throughput and ensure reliability. The UE may then, e.g. in case of a failed TB reception, propose to the gNB a better suited transmission parameter to be used in retransmitting the failed TB. The UE is in an advantageous position to calculate a suitable transmission parameter based on Signal-to-Interference plus Noise Ratio, SINR, measurements performed by the UE. The suitable, adapted transmission parameter or information related thereto is then transmitted to the gNB together with the NACK signal which represents a fast feedback, and enables the gNB to quickly adjust the retransmission of the failed TB, but potentially also other transmissions, e.g. transmissions of new TBs and/or new CBs, such that not only the failed TB can be quickly recovered, but also the successful decoding of newly received TBs is increased.

A User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
establish a connection towards the network node;
receive, from the network node, a UE capability request,
send, towards the network node, a UE capability information including the UE's capability to support sending assistance information in case of detecting a success and/or failure in decoding at least one received data packet, wherein at least one data packet, in particular, includes a Transport Block, TB, and/or a Code Block, CB,
receiving, from the network node, a configuration message including, in case the UE supports sending the assistance information, a configuration related to the use of the assistance information,
in case of detecting a success and/or failure in the decoding of the at least one received data packet, prepare an associated assistance information based on the configuration,
transmit, towards the network node, the prepared assistance information for enabling the network node to trigger actions related to at least one data packet to be send based on the assistance information,
wherein the UE is further configured to include information related to at least one transmission parameter different from a corresponding transmission parameter used for the transmission of the successfully and/or unsuccessfully decoded at least one data packet in the assistance information.

### List of Abbreviations

5QI 5G QoS Identifier
ACK Acknowledgement
ARQ Automatic repeat request
BLER Block error rate
CB Code block
CBG Code block group
DL Downlink
HARQ Hybrid ARQ
IE Information Element
LA Link adaptation
MAC Medium access control
MCS Modulation and coding scheme
NACK Negative ACK
PDB Packet delay budget
PDSCH Physical downlink shared channel
RB Radio Bearer
RE Resource element
RRC Radio resource control
TB Transport block
TBS TB size
TSC Time sensitive communication
UE User equipment
UL Uplink
URLLC Ultra reliable low latency communication
Qos Quality of service
XR extended Reality

1-34. (canceled)

35. A User Equipment, UE, configured to support a Hybrid Automatic Repeat Request, HARQ, process when communicating with a network node of a radio access network, the UE comprising:
at least one processor, and
at least one memory storing instructions that, when executed by the at least one processor, cause the UE at least to:
establish a connection towards the network node;
receive, from the network node, at least one Transport Block, TB;
carry out a Cyclic Redundancy Check, CRC, for decoding the received at least one TB;
in case of detecting a success in the decoding by determining that the received at least one TB passes the CRC check, prepare an assistance information;
transmit, towards the network node, information for indicating the success and the assistance information for enabling the network node to trigger actions related to one or more next TBs based on the assistance information,
wherein the UE is further configured to, in case of detecting the success, determine at least one transmission parameter based on Signal-to-Interference plus Noise Ratio, SINR, measurements performed by the UE, wherein at least one determined transmission parameter is different from a corresponding transmission parameter used for the transmission of the successfully decoded at least one TB, and
wherein the UE is further configured to include information related to at least one determined different transmission parameter in the assistance information, wherein a transmission parameter is related to at least one of number of retransmissions required for successful decoding of a TB at the UE, Modulation and Coding Scheme (MCS), and rank, and wherein the UE is further caused to:
measure an SINR value for the received at least one TB;
calculate a difference between a preset decodable SINR value and the measured SINR value; and
based on the calculated SINR difference value, determine the at least one transmission parameter for transmission of the one or more next TBs,
wherein in particular, the UE is further caused to indicate to the gNB the calculated SINR difference value for indicating the gNB to determine the at least one transmission parameter for transmission of the one or more next TBs.

36. The UE according to claim 35, wherein the UE is further caused to:
determine the at least one transmission parameter for transmission of the one or more next TBs when detecting that a number of retransmissions used for the successfully decoded at least one TB is larger than a predetermined retransmission number threshold.

37. The UE according to claim 35, wherein the transmission parameter is related to MCS, and the UE is further caused to:
indicate the network node, via the assistance information, to transmit the one or more next TBs with a modified MCS different from an initial MCS used for the successful transmission of the at least one TB.

38. The UE according to claim 37, wherein the UE is further caused to:
indicate the network node to increase an index of the initial MCS and to transmit the one or more next TBs with the modified MCS with the increased index, when determining that the calculated SINR difference value is larger than a first predetermined SINR threshold value,
wherein the first predetermined SINR threshold value indicates a minimum SINR difference value for triggering a modification of the MCS.

39. The UE according to claim 37, wherein the UE is further caused to:
indicate to the network node a maximum MCS index to which the initial MSC can be modified for transmitting the one or more next TBs with the modified MCS, wherein the maximum MSC index is determined by the UE as an index with which the UE could have decoded the received at least one TB with a predetermined block error probability.

40. The UE according to claim 37, wherein the UE is further caused to:
indicate the network node to decrease an index of the initial MCS and to transmit the one or more next TBs with the modified MCS with the decreased index, when determining that decoding of the one or more next TBs will fail when being transmitted by the gNB with the initial MCS, preferably by determining that the calculated SINR difference value is smaller than a second predetermined SINR threshold value,
wherein in particular the decreased MSC index is determined by the UE as an index with which the UE could have decoded the received at least one TB with a predetermined block error probability.

41. The UE according to claim 35, wherein the transmission parameter is related to number of retransmissions required for successful decoding of a TB at the UE and the UE is configured with a maximum allowed number of retransmissions required for successful decoding of a TB at the UE, wherein the UE is further caused to:
indicate the network node, via the assistance information, to decrease the maximum allowed number of retransmissions when determining that the calculated SINR difference value is larger than a third predetermined SINR threshold value.

42. The UE according to claim 41, wherein the UE is further configured to:
based on a preconfigured function, determine the decreased maximum allowed number of retransmissions, wherein the preconfigured function comprises input parameters including the calculated SINR difference value.

43. The UE according to claim 35, wherein the transmission parameter is related to rank, and the UE is further caused to:
indicate the network node, via the assistance information, to transmit the one or more next TBs with a modified rank different from an initial rank used for the successful transmission of the at least one TB.

44. The UE according to claim 43, wherein the UE is further caused to:
indicate the network node to increase the initial rank to the modified rank for transmitting the one or more next TBs, when determining that the calculated SINR difference value is larger than a fourth predetermined SINR threshold value,
wherein the fourth predetermined SINR threshold value indicates a minimum SINR difference value for triggering a modification of the rank.

45. The UE according to claim 43, wherein the UE is further caused to:
indicate to the network node a maximum rank to which the initial rank can be modified for transmitting the one or more next TBs with the modified rank, wherein the maximum rank is determined by the UE as a rank with which the UE could have decoded the at least one received TB with a predetermined block error probability.

46. The UE according to claim 43, wherein the UE is further caused to:
indicate the network node to decrease the initial rank to the modified rank and to transmit the one or more next TBs with the modified rank, when determining that decoding of the one or more next TBs will fail when being transmitted by the gNB with the initial rank, preferably when determining that the calculated SINR difference value is smaller than a fifth predetermined SINR threshold value.

47. A User Equipment, UE, configured to support a Hybrid Automatic Repeat Request, HARQ, process when communicating with another user equipment, the UE comprising:
at least one processor, and
at least one memory storing instructions that, when executed by the at least one processor, cause the UE at least to:
establish a radio connection towards the another user equipment via a direct link using device-to-device communication or sidelink communication;
receive, from the another user equipment, at least one Transport Block, TB, and/or at least one Code Block, CB;
carry out a Cyclic Redundancy Check, CRC, for decoding the received at least one TB and/or at least one CB;
in case of detecting a success in the decoding by determining that the received at least one TB and/or at least one CB passes the CRC check, prepare an associated assistance information,
transmit, towards the another user equipment, information for indicating the success and the assistance information for enabling the another user equipment to trigger actions related to one or more next TBs and/or CBs based on the associated assistance information,
wherein the UE is further configured to, in case of detecting the success, determine at least one transmission parameter based on Signal-to-Interference plus Noise Ratio, SINR, measurements performed by the UE, wherein at least one determined transmission parameter is different from a corresponding transmission parameter used for the transmission of the successfully decoded at least one TB and/or at least one CB, and
wherein the UE is further configured to include information related to at least one determined different transmission parameter in the assistance information.

48. A network node of a radio access network, configured to support a hybrid automatic repeat request, HARQ, process when communicating with a User Equipment, UE, the network node comprising:
at least one processor, and
at least one memory storing instructions that, when executed by the at least one processor, cause the network node at least to:
establish a connection towards the UE;
transmit, to the UE, at least one Transport Block, TB;
receive, from the UE, information for indicating a success in decoding the at least one TB at the UE and an associated assistance information prepared by the UE, wherein the assistance information includes information related to a transmission parameter different from a corresponding transmission parameter used for the transmission of the at least one successfully decoded TB; and
trigger actions related to one or more next TBs based on the assistance information for supporting successful decoding of the one or more next TBs at the UE, wherein the network node is further caused to:
transmit to the UE a resource radio control, RRC, message for configuring the assistance information and for indicating the UE to send to the network node the assistance information in case of a success in decoding the at least one TB at the UE, wherein the network node is further caused to:
transmit to the UE a first control element for configuring a first assistance information, for indicating determination of a first transmission parameter and for indicating the UE to send to the network node the first assistance information, in particular in case of a success in decoding the at least one TB at the UE; and
after receiving the first assistance information, transmit to the UE a second control element for configuring a second assistance information, for indicating determination of a second transmission parameter and for indicating the UE to send to the network node the second assistance information, in particular in case of a success in decoding the at least one TB at the UE,
wherein the first transmission parameter is different from the second assistance information, wherein the gNB is configured to configure and determine to transmit the first control element and the second control element based on information at the gNB related to the at least one TB.

49. The network node according to claim 48, wherein a transmission parameter is related to at least one of number of retransmissions required for successful decoding of a TB at the UE, Modulation and Coding Scheme, MCS and rank, wherein the network node is further caused to configure the UE with a maximum allowed number of retransmissions required for successful decoding of a TB at the UE,
wherein the assistance information indicates to decrease said maximum allowed number of retransmissions for the one or more next TB, wherein the network node is further caused to decrease said maximum allowed number of retransmissions for the one or more next TBs.
